(19) United States
(12) Patent Application Publication
(10) Pub. No.: US 2017/0061095 A1
(43) Pub. Date: Mar. 2, 2017

(54) SYSTEM AND METHOD FOR BEDSIDE MEDICATION DISPENSING

(71) Applicant: Carstens, Inc., Harwood Heights, IL (US)

(72) Inventors: David Waskin, Harwood Heights, IL (US); John Pierson, Harwood Heights, IL (US)

(21) Appl. No.: 15/250,378

(22) Filed: Aug. 29, 2016

Related U.S. Application Data
(60) Provisional application No. 62/212,194, filed on Aug. 31, 2015.

(51) Int. Cl. G06F 19/00; G07C 9/00

(52) U.S. Cl. CPC G06F 19/3462; G06F 19/322; G07C 9/00126

(57) ABSTRACT

A medical enclosure includes a frame that defines an enclosure for storing medical supplies. An electronic controller is integrated with the frame and configured to receive access credentials from a user. At least one door covers the enclosure, the door having a latch for securing the door to the frame, the latch being arranged to selectively lock and unlock the door in response to commands from the electronic controller. The electronic controller is programmed to unlock the door to provide access to the medical supplies to the user based on the user's credentials.

### CROSS-REFERENCE TO RELATED APPLICATIONS

The instant application claims the benefit of U.S. Provisional Patent Application Ser. No. 62/212,194, filed on Aug. 31, 2015, the contents of which are incorporated herein in their entirety by this reference.

### TECHNICAL FIELD

This patent disclosure relates generally to an apparatus and method for dispersing medication and, more particularly, to an apparatus and method for dispersing medication at a point of care.

### BACKGROUND

Typically, in a hospital or medical office environment, over 50% of a nurse's time is spent away from the patient when dispensing or administering medication and treatment. The time spent away from the patient includes time spent on walking, retrieving information, obtaining medication, and documentation. Traditionally, a clinical floor contains a centralized nurse station. The centralized nurse station is the primary work area assigned to a specific care unit and generally includes a reception area along with records storage and charting work areas. Time spent by a nurse at the centralized nurse station is time spent away from a patient. Moreover, to obtain medication for a patient, a nurse generally takes the attending physician's order to the pharmacy, waits to receive the medication from the pharmacy, then returns to the patient's room to administer the medication. The nurse may then return to the nurse's station to record the administration of the medication. The time it takes a nurse to walk to the pharmacy to obtain medical supplies and medication, and also the time to record the administration, is time spent away from a patient.

Time spent away from the point of care can also interrupt a clinician's workflow, which can also, possibly, cause medication and documentation errors. Medication and documentation errors create negative implications to both patients and healthcare facilities. A single mediation error can cost a healthcare facility hundreds of thousands of dollars, while mistakes in documentation lead to billing errors. In 2008, medical errors cost the United States healthcare industry about $19.5 billion. In addition, medication and documentation errors can lead to inefficient time use and increased costs in a healthcare environment.

### BRIEF SUMMARY

In one aspect, the disclosure describes a medical enclosure. The medical enclosure includes a frame defining an enclosure adapted for storing medical supplies, and at least one door connected to the frame, the door having an open position, in which access to the enclosure is provided, and a closed position, in which the enclosure is enclosed such that access to the enclosure from outside the frame is prevented. A latch is connected between the frame and a free end of the at least one door, the latch operating to lock the at least one door in the closed position and to unlock the at least one door, thus permitting the at least one door to move from the closed position to the open position, the latch being arranged to selectively lock and unlock the door in response to commands provided by the electronic controller. An electronic controller is integrated within the enclosure, the electronic controller being programmed and operating to: receive credentials from a user, compare the credentials with a list of authorized user credentials stored in a database, unlock the latch to permit the door to be opened by the user from the closed position to the open position, lock the latch if the user does not open the door within a predetermined period, and lock the latch when the door resumes the closed position after first assuming the open position.

In another aspect, the disclosure describes a method of dispensing medications at a point of care. The method includes storing medications in a lockable medical cabinet within a room at the point of care, the medical cabinet having at least one compartment and an authentication device, the authentication device configured to receive access credentials from a user, using the authentication device to receive credentials from a user, and comparing in an electronic controller that is operably associated with the authentication device the credentials provided by the user with a predefined list of authorized user credentials. When the user credentials are matched with an entry on the predefined list of authorized user credentials by the electronic controller, the electronic controller issues a command to instruct a latch that prevents opening of a door blocking access to the enclosure to unlock and allow the user to open the unlocked door and gain access into the compartment. Medications are retrieved from the compartment for dispensing to a patient in the room. The method further includes automatically locking the latch when the door is placed in the closed position.

In yet another aspect, the disclosure describes a method for tracking a plurality of medical cabinets and a plurality of users using a computer-implemented system. The system maintains a list of authorized user credentials in a database stored in a computer, the database being accessible by a plurality of electronic controllers, each disposed in a respective medical cabinet. Each medical cabinet of the plurality of medical cabinets includes an authentication device, a scanner device, a motion detection device, an enclosure, a door blocking the enclosure, and a latch, operably associated with the respective electronic controller disposed in the cabinet. A network interconnects the computer with the electronic controllers, the computer being programmed to track medications scanned at each medical cabinet and access of each medical cabinet by users.

### BRIEF DESCRIPTION OF THE DRAWINGS

FIG. 1 is a perspective view of a medical cabinet in accordance with the disclosure.

FIG. 2 is a flowchart illustrating steps of dispensing medication for administration to a patient at a point of care in accordance with the disclosure.

FIG. 3 is a flowchart illustrating steps of tracking a plurality of medical cabinets and a plurality of users using a computer-implemented system.

FIG. 4 is a schematic view of a clinical environment constructed in accordance with the disclosure.

FIG. 5 is a schematic view of a management system in accordance with the disclosure.

### DETAILED DESCRIPTION

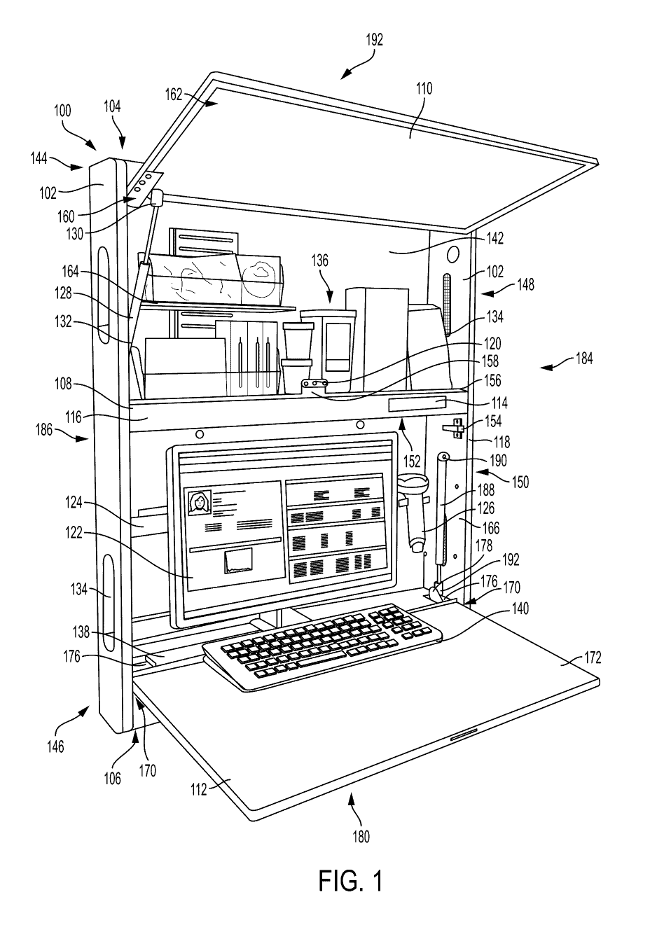

FIG. 1 is a medical cabinet 100, or medical enclosure, shown in a perspective view, in accordance with the disclosure. The medical cabinet 100 is an example of a medical enclosure and includes a top 104, bottom 106, and two side walls 102 that together form a frame 144. One of the two side walls 102 defines a left side 186 of the medical cabinet 100, and the other of the two side walls 102 defines a right side 184 of the medical cabinet 100. The frame 144 includes a front side 118 and a back side 146. The medical cabinet 100 further includes a back surface 142 that is connected to the back side 146 of the frame 144. In the illustrated embodiment, each of the two side walls 102 forms two vents 134 configured to circulate air through the interior of the medical cabinet 100. The vents 134 are optional and useful when heat sources such as electronic equipment are mounted in the cabinet interior to provide cooling when the cabinet doors are closed. The medical cabinet 100 may further include interior and/or exterior lighting fixtures incorporated in its structure. In operation, the interior lighting may be configured to increase visibility of medical supplies within the medical cabinet 100, while the exterior lighting may be configured to illuminate the room, and also act as a night-light. Further, in some embodiments, various components and work surfaces of the medical cabinet 100 may be impregnated or otherwise include anti-microbial agents to reduce possible cross contamination.

As shown in FIG. 1, a first shelf 108 is disposed within the frame 144 and adjacent the two side walls 102. The first shelf 108 includes a back surface 152, a front surface 116, and a top surface 156. The back surface 152 of the first shelf 108 is disposed adjacent the back surface 142 of the medical cabinet 100, and the front surface 116 of the first shelf 108 is disposed adjacent the front side 118 of the frame 144. The first shelf 108 is positioned halfway between the top 104 and the bottom 106 of the medical cabinet 100, but other locations can be used depending on the size of the cabinet and the size of the supplies that will be stored therein. The first shelf 108 includes an electronic controller such as a card reader 114 and two latches 120. The card reader 114 is disposed within the first shelf 108 and flush with the front surface 116 of the first shelf 108. The first shelf 108 forms a lip 158 along its top surface 156 adjacent the front surface 116. The lip 158 extends towards the top 104 of the medical cabinet 100. The latches 120 (one visible) are disposed on top and beneath the shelf 108 to releasably and selectively engage and disengage the cabinet doors. The top latch 120 that engages the top door is connected to the lip 158 on the side adjacent the front surface 116 of the first shelf 108.

The two side walls 102, the top 104, and the first shelf 108 form a first compartment 148. A first door 110 is hinged along its top portion and swings down to cover an opening of the first compartment 148. When closed, the first door 110 engages the top latch 120 to close the first compartment 148. The first compartment 148 is configured to store medical supplies 136. Medical supplies 136 include gloves, bandages, containers, syringes, medicines, and any other product needed to administer care to a patient. The medical supplies 136 may include a bar code that may be scanned with a LASER scanner, or have appropriate chips that can be identified with use of a radio frequency identification (RFID) scanner. The first compartment 148 includes a second shelf 164 that is configured to store medical supplies 136. In alternative embodiments, the first compartment 148 may include any number of shelves in any number of sizes and shapes.

The first door 110 is pivotally connected to the side walls 102 via two first door hinges 160. The two first door hinges 160 are positioned near the top 104 of the medical cabinet 100 such that the first door 110 swings upwards when in an open position. A first actuator 128 includes a first end 130 and a second end 132. The first door 110 includes a top left corner 168 and an inside surface 162. The first end 130 of the first actuator 128 is connected to an inside surface 162 of the first door 110 near the top left corner 168, and the second end 132 of the first actuator 128 is connected to an inside surface 166 of one of the side walls 102 on a left side 186 of the medical cabinet 100. In use, when the first compartment 148 is in an open position, the first actuator 128 is configured to hold the first door 110 in place and prevent the first door 110 from swinging downwards from the force of gravity. The first door 110 requires additional force from a person to close. When the first compartment 148 is in a closed position, a catch (not shown) disposed on the inside surface 162 of the first door 110 engages the latch 120 of the first shelf 108 to lock the first door 110 in the closed position. In operation, the card reader 114 and other electronics and access controls are configured to release the latch 120 and allow the first door 110 to open when proper credentials are entered by the user into the card reader 114.

The two side walls 102, the bottom 106, and the first shelf 108 also form a second compartment 150. A second door 112 is configured to cover the second compartment 150. The second compartment 150 may include a bar code scanner 126 mounted to the back surface 142 of the medical cabinet 100. The second compartment 150 includes a third shelf 138, the third shelf 138 disposed between the side walls 102 and near the bottom 106 of the medical cabinet 100. The third shelf 138 may support a computer 122. Alternatively, the computer 122 may be mounted to the back surface 142 of the medical cabinet 100 via a monitor mount 124. The third shelf 138 forms a first square bore 174 near the left side 186 of the medical cabinet 100 and a second square bore 176 near the right side 184 of the medical cabinet 100. Both the first square bore 174 and the second square bore 176 extend from adjacent a top surface of the third shelf 138 to adjacent a bottom surface of the third shelf 138.

The second door 112 is pivotally connected to the side walls 102 via a pair of second door hinges 170 such that the second door 112 swings downwards when in an open position. In addition to providing a closure for the second compartment 150, a top surface 172 of the opened second door 112 also provides a work surface for the user, for example, to provide a writing surface and/or a support for other devices such as the keyboard 140. The pair of second door hinges 170 is positioned close to the bottom of the door such that the door swings down when opening. The second door 112 may be formed of metal. The top surface 172 of the second door 112 forms a gusset 178 near its bottom right corner 182 near the right side 184 and the bottom 106 of the medical cabinet 100. A second actuator 188 includes a first end 190 and a second end 192. The first end 190 is pivotally connected to an inside surface 166 on the right side 184 of the medical cabinet 100. The second end 192 of the second actuator 188 is pivotally connected to the gusset 178.

In operation, when the second compartment 150 is in an open position, the gusset 178 passes through the second square bore 176 and the third shelf 138 is configured to prevent the second door 112 from swinging further downwards past a position perpendicular to the back surface 142 of the medical cabinet 100. In operation, when the second compartment 150 is swung into a closed position, the second actuator 188 is configured to assist with closing the second door 112 as well as to hold the second door 112 in place and prevent the second door 112 from swinging downwards from the force of gravity. A pair of magnetic catches 153 are disposed on the inside surface 166 of each of the side walls 102 near the first shelf 108. When the second compartment 150 is in a closed position, the magnetic catches 153 are configured to further secure the second door 112 to the cabinet frame 114 of the medical cabinet 100. When closed, the second door 112 engages the second latch 120 to maintain the door closed.

An outside surface 180 of the second door 112 and an outside surface of the first door 110 each forms a handle (not shown), the handles configured to allow a user to open the first door 110 and the second door 112, respectively.

The medical cabinet 100 may include a communication device configured to communicate at least one of audio and video signals to other medical cabinets located elsewhere, and/or to other communication devices, for example, a communication device located at the nurse's station or at a physician's office. The communication device may include at least one of a networked camera, a microphone, and a speaker.

The medical cabinet 100 may further include a noise mitigation speaker configured mitigate ambient noise in a room. The noise mitigation speaker can be configured to use active noise cancellation to mitigate ambient noise in the patient's room such as use of white noise to mask ambient sounds.

The medical cabinet 100 may include a motion detector configured to indicate when an authorized user is nearby or to activate a switch. The switch may be configured to automatically open or close a compartment door of the medical cabinet 100.

In one embodiment, the card reader 114 is configured to control access to a single compartment, or alternatively, multiple compartments. In operation, a card is assigned to each authorized user, the card including credentials for that authorized user. The card is configured to give the authorized user access to one or more compartments. Different authorized users may have varying degrees of access to the compartments of the medical cabinet 100. For example, if the medical cabinet 100 includes four compartments, a first authorized user, for example a nurse, may have access to all four of the compartments while a second authorized user, for example an orderly, may have access to two of the compartments.

For a medical cabinet 100 that includes multiple locked compartments, access to individual compartments may be granted via a card swipe plus a key code. To gain access to a first compartment, the authorized user may swipe their card followed by pressing a first button or key in a code on the keypad. To gain access to a second compartment, the authorized user may swipe their card followed by pressing a second button or entering a different code on the keypad, and so on. If the authorized user does not have credentials to access a particular compartment, the authorized user will be denied access following a card swipe and pressing of a button corresponding to that particular compartment. If an unlocked compartment does not open in a predetermined period, the controller may re-lock the cabinet to discourage unauthorized entry.

Authorized users may be assigned into groups, each group having a similar level of access to the medical cabinet 100. For example, a first nurse may belong to an Administrative Level group, which gives access to all compartments. A second nurse may belong to a Nurse Level 1 group, which gives access to a few compartments. An orderly may belong to a Basic group, which gives access to only one compartment.

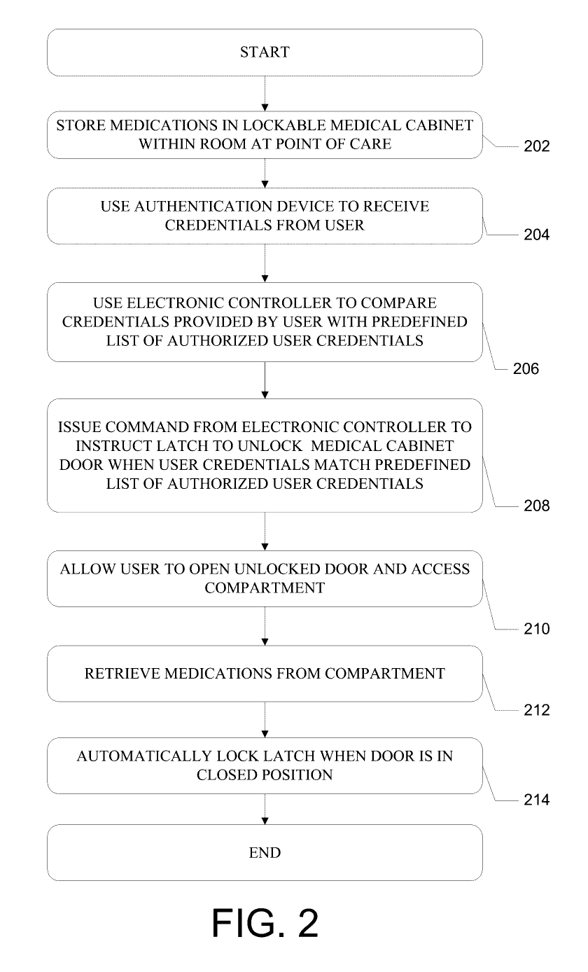

FIG. 2 shows a flowchart illustrating method for dispensing medication for administration to a patient at a point of care in accordance with the disclosure. At step 202, medications are stored in a lockable medical cabinet within a room at a point of care. The medical cabinet may contain pharmaceuticals, electronic devices, and other supplies needed to administer care, which can collectively be referred to as medical supplies.

In accordance with the process, at step 204, a user provides authentication credentials to an authentication device. The authentication credentials may be provided in any appropriate or known fashion, including entry of a personal identification code onto a keypad, scanning of a bar code or a card having radio frequency identification information (RFID) stored thereon, and the like. In the illustrated embodiment, the user passes an RFID card or fob over a reader device that is associated with the authentication device, which causes the user's credentials to be read by the system. The authentication device performs an authenticity check based on the user's credentials. In the illustrated embodiment, the authentication device compares the user's credentials with a list of authorized user credentials to determine if the user credentials that were entered represent an authorized user. Alternatively, or in addition, the medical cabinet may also include a keypad, an RFID scanner, a biometric reader and the like for separately authenticating a user's access to one or more compartments of the cabinet, and/or to add an additional layer of authentication.

In accordance with step 206, an electronic controller that is operably associated with the authentication device compares the credentials provided by the user with a predefined list of authorized user credentials. At 208, when the user credentials are matched with an entry on the predefined list of authorized user credentials by the electronic controller, the electronic controller issues a command to instruct a latch that prevents opening of a door blocking access to a compartment of the medical cabinet to unlock. If the credentials of an authorized user are entered, one or more compartments of the medical cabinet are unlocked based on the particular authentication level of the user. At 210, a compartment unlocked at step 208 is free to be opened by the user, and may remain in an unlocked state for a predetermined period. A sensor associated with the electronic controller may be used to sense whether the door is open or closed. If a user fails to open the compartment before the period expires, for example, after 15 seconds, the compartment may be locked again requiring a re-authentication by the user. The other compartments may remain closed. In one embodiment, only one compartment can be opened at any one time. For example, the system may include sensors providing information indicative that all other doors are closed before any one door is unlocked and allowed to open. At step 212, medical supplies may be retrieved or added to the interior of the compartment after the compartment has been opened. A motion sensor associated with the electronic controller may be used to detect removal of a medication from the compartment by the user. At 214, the compartment that was opened at 210 may be closed by the user and, when closed, the compartment may be locked automatically upon closure.

A compartment of the medical cabinet that contains an electronic recording device may be opened after medical supplies are retrieved. The electronic recording device may include, but is not limited to, a computer or a tablet. The compartment that contains the electronic recording device may include other electronic devices. A patient's bar code may be scanned with a bar code scanner to confirm the patient's identity. The patient's bar code is typically found on a band tied about a patient's wrist. The bar code scanner may be used to scan the medical supplies to identify the medication. The dispensed medication may be compared against the particular patient's prescribed medication. An alarm may sound when the dispensed medication is not on the particular patient's prescribed list of medications.

The bar code scanner may be placed within the compartment containing the electronic device. Medical supplies may be administered to the patient after the patient's identity is confirmed. The electronic recording device may be used to document treatment at the point of care. The documentation may include, but is not limited to, the medical supply administered, the time of administration, the dosage, the attending physician and/or nurse, and other relevant information. The documentation at the point of care may reduce documentation error because there is less risk of interruption to a clinician's workflow. The compartment of the medical cabinet that contains the electronic device may then be closed, placing the medical cabinet in a stowed position.

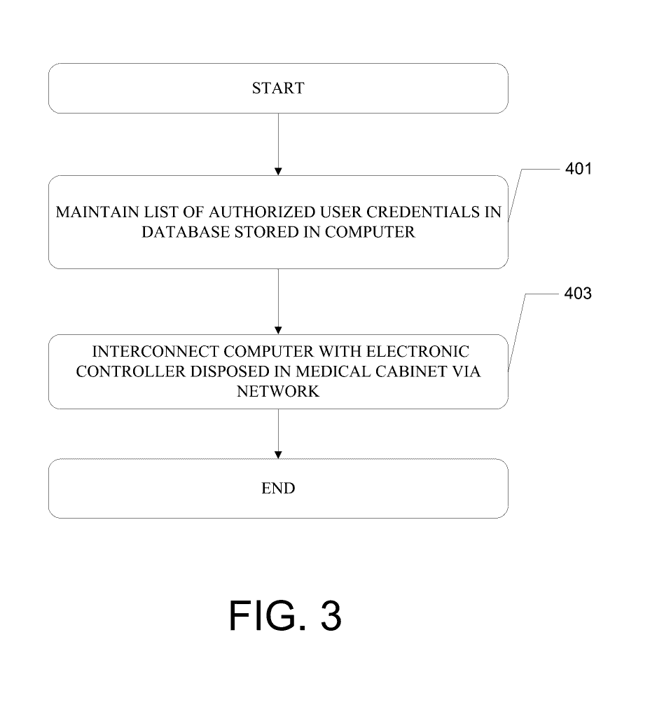

FIG. 3 shows a flowchart illustrating steps of tracking a plurality of medical cabinets and a plurality of users using a computer-implemented system. At step 401, a list of authorized user credentials is maintained in a database stored in a computer, the database being accessible by a plurality of electronic controllers, each disposed in a respective medical cabinet. Each medical cabinet of the plurality of medical cabinets includes an authentication device, a scanner device, a motion detection device, an enclosure, a door blocking the enclosure, and a latch, operably associated with the respective electronic controller disposed in the medical cabinet. At 403, a network interconnects the computer with the electronic controllers, the computer being programmed to track medications scanned at each medical cabinet and access of each medical cabinet by users. The medications may include bar codes that are interpreted by the scanner device, which provides the electronic controller signals that are relayed to the computer. The database may further include information on approved medications that a user can dispense for a patient in each of the rooms. The motion detection device may detect when medications are removed from the enclosure and provides a signal to the electronic controller, which relays signals to the computer.

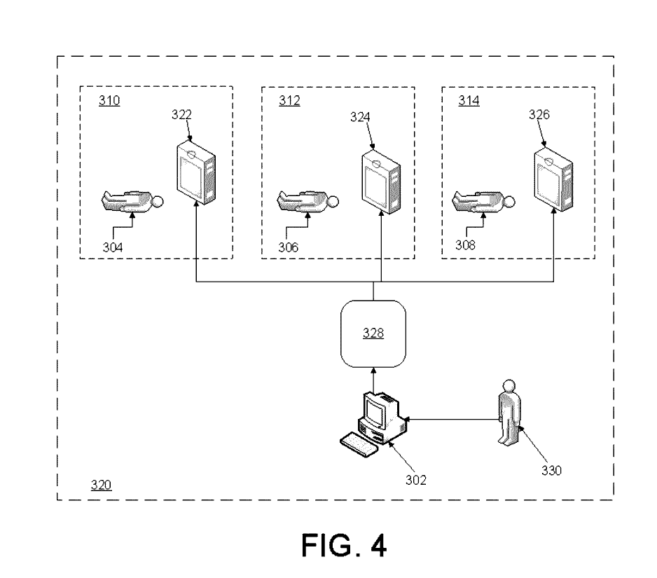

Referring to FIG. 4, an embodiment of a clinical environment 320 following principles of the disclosure is shown that includes a computer 302 and a network 328. The clinical environment 320 is meant to encompass an area where patients undergo medical treatment, for example, a hospital or clinic. A first room 310 includes a first patient 304 and a first medical cabinet 322, a second room 312 includes a second patient 306 and a second medical cabinet 324, and a third room 314 includes a third patient 308 and a third medical cabinet 326. Although three patient rooms are shown for illustration, a single room or more than one room may be thus equipped. The computer 302 is configured to track a single medical cabinet or a plurality of medical cabinets via the network 328. For example, the computer 302 can track the date and time when a user accesses a medical cabinet. The computer 302 maintains credentials for a plurality of users 330. In the illustrative embodiment, the computer 302 is configured to track the first medical cabinet 322, the second medical cabinet 324, and the third medical cabinet 326. The user 330 may be a nurse, clinician, or other person authorized to open any of the medical cabinets 322, 324, 326. The computer 302 can include a number of computer systems or mobile devices, which generally can include any type of computer system based on: a microprocessor, a mainframe computer, a digital signal processor, a portable computing device, a personal organizer, a device controller, or a computational engine within an appliance. In some embodiments, the computer 302 is implemented in one or more electronic devices that are located in one or more locations. The computer 302 is configured to provide an audit trail and history reports for each medical cabinet. In the event the computer 302 is down, computers and/or other electronic devices integrated with each cabinet may operate independently and in accordance with the last set of instructions for user access to the cabinets that was provided by the computer 302, with which each of the controllers in the cabinets are in informational communication or other operative linkage.

The network 328 can generally include any type of wired or wireless communication channel capable of coupling together computing nodes. Examples of a suitable network 328 include, but are not limited to, a local area network, a wide area network, Internet, Intranet, LAN, WAN, or a combination of networks. The computer 302 is flexible and scalable to include tracking of additional medical cabinets. The computer 302 includes other modules and computer-executable instructions adapted to carry out other steps and features of a method for tracking a plurality of medical cabinets and a plurality of users. The computer 302 may include a database or data storage device that can include any type of system for storing data in non-volatile storage. This includes, but is not limited to, systems based upon: magnetic, optical, and magneto-optical storage devices, as well as storage devices based on flash memory and/or battery-backed up memory. The computer 302 can contain a permission database which stores user credentials and permissions specific to users 330 that are active.

In addition to the components discussed above, the computer 302 can further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

It should be appreciated that the systems and methods described herein may be implemented in other modes such as mobile carts and the like, which may include drawers and/or cabinet portions that are selectively accessible by users. In such mobile solutions, communication between the computer 302 and the cabinet or cart can be carried out in a secure, wireless fashion.

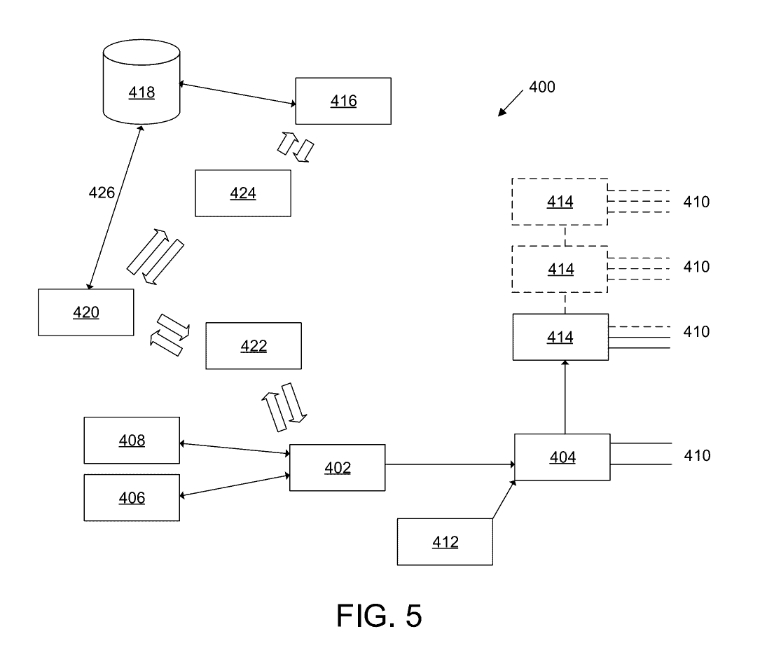

A schematic diagram for a management system 400 for managing a bedside medication dispensing system as described herein is shown in FIG. 5. The management system 400 in the illustrated embodiment utilizes a Bluetooth® communication protocol for short-range exchange of information and data between various portions of the system, but other types of wireless communication may be used. More specifically, the management system 400 includes a Bluetooth® radio chip 402 that can contain typical components such as a microprocessor and non-volatile flash memory—to retain the last updated data in the event of power loss or a loss of communication—that contains the personalized employee rules for access to drawers and doors of a cabinet. The radio chip 402 is communicatively connected to a control board 404 that is integrated with a particular cabinet or group of cabinets, as previously described. The radio chip 402 and, thus, the control board 404, receive information from various external sources that are accessible by a user such as a keypad or keyboard 406, a RFID card reader 408, and/or any other known type of input device such as biometric input devices that can receive credential information about a user from the user.

During operation, the radio chip 402 receives user identification information, for example, from the RFID reader 408 and/or the keypad 406, and provides the user information, either encrypted or unencrypted, to the control board 404. Either the radio chip 402 or the control board 404 compares the user credentials received to predefined user authorization information stored locally in a database (not shown) and, if the user has appropriate permissions, sends a command 410 to a mechanical latch to open, as previously described. The control board 404 may also communicate with other systems 412, such as a controller for a locking system, barcode reader, and the like, to perform various additional functions as previously described, for example, logging medications dispensed to a patient and the like.

In the illustrated embodiment, the communications with the control board 404 are carried out using three conductors, two of which carry one data bit each (referred to as T0 and T1) and the third of which acting as a data ready line to designate which latches are to open. To stay within the power requirements of the system, a maximum of two doors are unlatched at a time, with any additional doors opening two at a time until all doors to be accessed are opened. in the embodiment shown, two command lines 410 are shown to operate two latches, but additional latches can be operated with relays 414 that are connected to the control board 404.

For providing the appropriate user authorizations to the system, and for also tracking and auditing access of users into the system over time, the system 400 includes an administrator computer (or protected cloud client) 416, which can operate locally or remotely to the installation using the cabinets. The administrator computer 416 communicates with a master database 418, which may be maintained locally on servers or may be maintained in the cloud. The master database 418 may also be accessible by a mobile or local administrator computer 420 that operates at the particular facility in which the various cabinets are used.

The primary or master database 418 can contain various types of information that are protected and accessed only by the administrators of the system. Such information includes employee name, employee number, RFID badge, keypad PIN number, days of the week where access is allowed, limited times of access during the days, employee security level, badge expiration date and which doors are to be opened when a PIN and/or badge is read. Only the portion of the database 418 that is pertinent to a particular control board 404 is downloaded to that board or to the Bluetooth® module, to both minimize the download time and to restrict date available to hacking. For downloading the database of permissions to the control board, various systems are used. In the embodiment shown, the database 418 is first accessed by the local administrator computer 420, and is then sent as a package 422 directly to the control board 404 via Bluetooth® or another local, secure, wireless connection. For downloading the portion of the database, the local administrator computer 420 may also have to be physically close to the administrator computer 416 to receive a package 424 of information. Any unauthorized viewer of the Bluetooth® in the packages 424 and 422 data stream would obtain only minimal information, since information such as employee name and employee number and access to drawers in other rooms are not stored in the Bluetooth® module. As an additional security measure, the data inside Bluetooth® module and not transmitted from the local administrator computer 420, can be configured such that it is not transmitted to an outside device, but only replaced in its entirety by the package 422 sent by the local administrator computer 420.

During use, when an ID card is presented and read by the RFID device 408, the card data is sent to the Bluetooth® device 402. The Bluetooth® device 402 scans the database for the corresponding line in the database to determine if a PIN number is required and if the ID is valid for that set of doors. A red and green LED plus tone (not shown) or another visual or audible indication may signal to the user if the card is valid. Lines in the database would also indicate if a given PIN or RFID card should initiate an alarm sound be generated by the controller to alert others in the area that a targeted employee had attempted to open unauthorized door.

The database in the Bluetooth® device is updated by an administrator when near (within 30 feet) the Bluetooth® device 402, i.e., when the package 422 is sent and received. The database within the local administrator computer 420 may be updated through the computer's internet connection 426 with the database 418, or by Bluetooth® link to the administrator computer 416, i.e., through package 424. The Bluetooth® device 402 does not itself connect directly to the internet. The template with which information is organized and stored in the master database 418 is modifiable to meet a particular customer's requirements and a spread sheet program could be created to allow easy shortcuts that fill in most common data fields.

An audit trail is stored as a spread sheet inside the Bluetooth® device 402, with an entry in the log every time a door is opened or attempted to open. This audit trail file is uploaded into the local administrator computer 420 at any link opportunity, for example, when the package 422 is updated. The local log file is then routed through using the administrator local computer's connections with the master database 418, and is saved there for later review. Each line in the audit or log file includes relevant information such as RFID, PIN, drawers opened, and time of each failed or successful, i.e., authorized, access event. The audit trail file can also remain in the Bluetooth® module memory for either some preset time (one or two years) or until the memory exceeds some present number of events, for example, 2000 records.

The installer would simply plug the RFID reader, keypad, or near field reader cables into the Bluetooth® device. The Bluetooth® device may be configured to accept up to three input devices. During installation, the Bluetooth® device may be plugged into a port of the control board 404, and power for the input devices is supplied through the Bluetooth® device, which in turn receives power from the control board 404, which may receive its power via a wall type adapter and/or a battery. If power is lost, the unit may not operate if used without a battery but regardless of its power supply type, the database and audit trail information remains unaltered and stored in flash memory. Should the program need to be updated within the Bluetooth® device, new program code can be downloaded from the local administrator computer 420 and installed automatically during a database update.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A medical enclosure, comprising:
a frame defining an enclosure adapted for storing medical supplies;
at least one door connected to the frame, the door having an open position, in which access to the enclosure is provided, and a closed position, in which the enclosure is enclosed such that access to the enclosure from outside the frame is prevented;
a latch connected between the frame and a free end of the at least one door, the latch operating to lock the at least one door in the closed position and to unlock the at least one door, thus permitting the at least one door to move from the closed position to the open position, the latch being arranged to selectively lock and unlock the door in response to commands provided by an electronic controller;
the electronic controller integrated within the enclosure, the electronic controller being programmed and operating to:
receive credentials from a user;
compare the credentials with a list of authorized user credentials stored in a database;
unlock the latch to permit the door to be opened by the user from the closed position to the open position;
lock the latch if the user does not open the door within a predetermined period; and
lock the latch when the door resumes the closed position after first assuming the open position.

2. The medical enclosure of claim 1, wherein the electronic controller receives credentials from the user via a radio frequency identification card.

3. The medical enclosure of claim 1, wherein the electronic controller maintains a database of user credentials that is updated through a local administrator computer via wireless communications.

4. The medical enclosure of claim 3, wherein electronic controller receives an information package that includes only those user credentials that can access the enclosure.

5. The medical enclosure of claim 3, wherein a remote, master database contains credentials for all users that can access all enclosures in a system.

6. The medical enclosure of claim 1, wherein the frame includes one or more shelves, and wherein the frame and the one or more shelves define two or more compartments, each compartment being separately enclosed by a respective door having a respective latch, each respective latch being operatively associated with the electronic controller.

7. The medical enclosure of claim 6, wherein the frame defines at least one compartment configured to store medical supplies.

8. The medical enclosure of claim 6, wherein the database contains a list of authorized user credentials corresponding to each of the two or more compartments.

9. The medical enclosure of claim 1, wherein each medical supply adapted to be stored in the medical enclosure includes a bar code configured to be scanned with a laser scanner.

10. The medical enclosure of claim 9, further comprising a laser scanner operatively associated with the electronic controller, the laser scanner being operable to scan each medical supply dispensed from the enclosure by the user, wherein the database further contains information relative to medications that a user is authorized to dispense from the enclosure, and wherein the electronic controller further operates to sound an alarm when a user dispenses an unauthorized medication from the enclosure based on a comparison between information about the medication provided via the laser scanner and the user's authorization to dispense the medication.

11. The medical enclosure of claim 1, further comprising a motion detector device associated with the controller, the motion detector device operating to provide information to the electronic controller indicative of medications being removed from the enclosure.

12. A method of dispensing medications at a point of care, comprising:
storing medications in a lockable medical cabinet within a room at the point of care, the medical cabinet having at least one compartment and an authentication device, the authentication device configured to receive access credentials from a user;
using the authentication device to receive credentials from the user;
comparing in an electronic controller that is operably associated with the authentication device the credentials provided by the user with a predefined list of authorized user credentials;
when the user credentials are matched with an entry on the predefined list of authorized user credentials by the electronic controller, issuing a command from the electronic controller to instruct a latch that prevents opening of a door blocking access to the medical cabinet to unlock;
allowing the user to open the unlocked door and gain access into the compartment;
retrieving medications from the compartment for dispensing to a patient in the room; and
automatically locking the latch when the door is placed in a closed position.

13. The method of claim 12, further comprising sensing whether the door is open or closed by use of a sensor associated with the electronic controller, and automatically locking the door within a predefined period after the user enters credentials sufficient to unlock the door if the door is not opened within the predetermined period.

14. The method of claim 12, further comprising:
using a motion sensor associated with the electronic controller to detect removal of a medication from the compartment by the user;
scanning the medication with a scanner associated with the electronic controller to identify the medication;
scanning a patient identification tag with the scanner to identify the patient;
comparing the dispensed medication against the particular patient's prescribed medication,
documenting the dispensing of the medication for the particular patient; and
sounding an alarm when the dispensed medication is not on the particular patient's prescribed list of medications.

15. The method of claim 12, wherein the authentication device is a card reader.

16. The method of claim 12, wherein the medical cabinet includes more than one separate enclosures, each with a corresponding door, latch and list of authorized users, and wherein the electronic controller is programmed to open any of the more than one doors automatically based on the user credentials.

17. A method for tracking a plurality of medical cabinets and a plurality of users using a computer-implemented system, comprising:
maintaining a list of authorized user credentials in a database stored in a computer, the database being accessible by a plurality of electronic controllers, each disposed in a respective medical cabinet;
wherein each medical cabinet of the plurality of medical cabinets includes an authentication device, a scanner device, a motion detection device, an enclosure, a door blocking the enclosure, and a latch, operably associated with the respective electronic controller disposed in the medical cabinet;
wherein a network interconnects the computer with the electronic controllers, the computer being programmed to track medications scanned at each medical cabinet and access of each medical cabinet by users.

18. The method of claim 17, wherein the medications include bar codes that are interpreted by the scanner device, which provides the electronic controller signals that are relayed to the computer.

19. The method of claim 18, wherein the motion detection device detects when medications are removed from the enclosure and provides a signal to the electronic controller, which relays signals to the computer.

20. The method of claim 19, wherein the database further includes information on approved medications that a user can dispense for a patient in each of the rooms.
